(19) United States
(12) Patent Application Publication
(10) Pub. No.: US 2004/0118249 A1
(43) Pub. Date: Jun. 24, 2004

(54) PROCESS FOR SEPARATION/RECOVERY OF PLATINUM GROUP METALS

(75) Inventors: Satoshi Asano, Niihama-shi (JP); Yoshiaki Manabe, Niihama-shi (JP); Atsushi Fukui, Niihama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sumitomo Metal Mining Co., Ltd., Tokyo (JP)

(21) Appl. No.: 10/681,319

(22) Filed: Oct. 9, 2003

(30) Foreign Application Priority Data
Oct. 8, 2002 (JP) 2002-294377

(51) Int. Cl. C22B 3/28

(52) U.S. Cl. 75/722

(57) ABSTRACT

### Abstract of the Disclosure

A process for separation/recovery of PGM by selectively adsorbing and eluting PGM in the form of chloride, e.g., chloro complex, irrespective of its form, using an ion exchange resin from a chloride solution containing PGM at a relatively low concentration and an impurity element at a high concentration. The process for separation/recovery of PGM from a solution containing the PGM and an impurity element, comprising the first step of selectively adsorbing the PGM by bringing polyamine-based anion exchange resin into contact with the solution to form adsorption-treated resin, second step of washing the adsorption-treated resin to form a washing-treated resin, and third step ofeluting the PGM from the washing-treated resin.

### Detailed Description of the Invention

### Cross Reference to Related Applications

This application is based on an earlier invention by the present inventors described at least in Japanese patent application 2002-294377, filed in the Japanese Patent Office on October 8, 2002.

### Background of Invention

### FIELD OF THE INVENTION

The present invention relates to a process for separation/recovery of platinum group metals (PGM), more particularly a process for separation/recovery of PGM by selectively adsorbing and elution of PGM in the form of chloride, e.g., chloro complex, irrespective of its form, using an ion exchange resin from a chloride solution containing PGM at a relatively low concentration and, at the same time, an impurity element at a high concentration.

### DESCRIPTION OF THE PRIOR ART

PGM are scarce resources, and production of the natural minerals, e.g., platinum ores containing PGM at a high concentration, is limited. The starting materials for PGM produced on a commercial scale are mostly byproducts from refining of nonferrous metals, e.g., copper, nickel and cobalt, and various spent catalysts, e.g., those for treating automobile exhaust gases.

The byproducts from nonferrous metal refining contain PGM, e.g., platinum, palladium, iridium, rhodium, ruthenium and osmium present in the refining starting materials in trace quantities. They are concentrated, for their properties, in the sulfide concentrates of the major metals, e.g., copper and nickel, and in the crude metals. They are separated in the form of noble metal concentrate containing PGM as the residue from a major metal recovery process, e.g., electrolysis.

The concentrate normally contains, in addition to copper and nickel as the major metals, other components, e.g., noble metals (e.g., gold and silver), group VI elements (e.g., selenium and tellurium) and group V elements (e.g., arsenic), which are present at a higher concentration than PGM. Recovery of PGM follows recovery of gold and silver. They are normally leached in a solution, and then purified/separated by solvent extraction or ion exchange to be recovered.

One of the conventional techniques for recovering PGM by ion exchanging brings a solution containing the PGM into contact with a quaternary ammonium salt type anion exchange resin to adsorb palladium and platinum or/and rhodium thereon, and treats the resin for consecutive elution under specific conditions to separate PGM of practical purity efficiently from each other (disclosed by, e.g., Japanese Patent Laid-open Publication No.07-310129 (Pages 1 and 2)).

This process utilizes the phenomenon that the ion exchange resin of the above type well adsorbs a chloro complex stable in a chloride solution, e.g., hexachloro complex of platinum or tetrachloro complex of palladium. It is mainly intended to separate PGM present at a high concentration in a solution from each other. For example, rhodium is weakly adsorbed and easily eluted out in an acid washing step. Therefore, the process has a problem when a solution containing rhodium at a low concentration is to be treated. Moreover, it is difficult for the above resin to adsorb iridium, ruthenium and osmium, because the hexachloro complex of each tetravalent element is unstable and easily decomposed when concentration of the chloride ion decreases.

A specific vinyl pyridine-based adsorbent is proposed as the one exhibiting high adsorption activity for an indifferent metal complex of rhodium or the like (disclosed by, e.g., Japanese Patent Laid-open Publication No.09-225203 (Page 2)). However, a pyridine-based ion exchange resin well adsorbs many transition metal ions, e.g., copper ion, and difficult to selectively adsorb/separate PGM.

Another technique for selectively adsorbing PGM (e.g., ruthenium and palladiumand technetium) in a nitric acid solution uses an anion exchange resin with a nitrogen-containing heterocyclic group as the functional group or weakly basic anion exchange resin with a primary to secondary amine group as the functional group, and consecutively recovers the adsorbed ruthenium, palladium and technetium by elution with a specific eluent (disclosed by, e.g., Patent Document 3). However, it involves industrial problems in that anion exchange resins in general tend to be degraded in the presence of nitric acid, which limits repeated use of the resin, and it needs a countermeasure against rapid oxidation-reduction reactions occurring in the resin, because a nitric solution, e.g., concentrated nitric acid, is also used for elution.

The industrial process for leaching PGM from a starting material containing the PGM preferably forms a chloride solution from which the PGM can be separated in a high yield in the form of chloride stable in a solution, e.g., chloro complex. The leached element generally leaves an impurity element at a high concentration, in addition to PGM, in the solution.

The conventional technique (disclosed by, e.g., Japanese Patent Laid-open Publication No.09-225203 (Page 2) or Japanese Patent Laid-open Publication No.08-269585 (Page 2)), when used to separate/recover PGM from the chloride solution, needs transformation of the compound into an indifferent or nitric complex compound. However, it is industrially difficult to transform all of the metals into their complexes in a solution massively containing an impurity element.

Therefore, there have been great demands for the processes that can separate/recover PGM, irrespective of its form, on a commercial scale from a chloride solution containing PGM at a relatively low concentration and, at the same time, an impurity element at a high concentration (chloride solution is most useful solution on a commercial scale).

### Summary of Invention

It is an object of the present invention to provide a process for separation/recovery of PGM by selectively adsorbing and elution of PGM in the form of chloride, e.g., chloro complex, irrespective of its form, using an ion exchange resin from a chloride solution containing PGM at a relatively low concentration and, at the same time, an impurity element at a high concentration, in consideration of the problems involved in the conventional techniques.

The inventors of the present invention have found, after having extensively studied to solve the above problems, that PGM can be efficiently separated/recovered from a chloride solution containing the PGM at a relatively low concentration by the use of a polyamine-based anion exchange resin, in spite of an impurity element present in the solution at a high concentration, achieving the present invention.

The first aspect of the present invention is a process for separation/recovery of PGM from a chloride solution containing the PGM and an impurity element, comprising the first step for selective adsorption of the PGM by bringing a polyamine-based anion exchange resin into contact with the solution, second step for washing the adsorption-treated resin, and third step for elution of the PGM from the washing-treated resin.

The second aspect of the present invention is the process of the first aspect for separation/recovery of PGM, wherein the chloride solution is kept at an oxidation-reduction potential of 700 to 1100mV (based on an Ag/AgCl electrode).

The third aspect of the present invention is the process of the first aspect for separation/recovery of PGM, wherein the adsorption-treated resin is washed with a diluted hydrochloric acid solution or water, or diluted hydrochloric acid solution and water successively in this order in the second step.

The fourth aspect of the present invention is the process of the third aspect for separation/recovery of PGM, wherein the diluted hydrochloric acid solution has a chloride ion concentration of below 4 mol/L.

The fifth aspect of the present invention is the process of the first aspect for separation/recovery of PGM, wherein the washing-treated resin is brought into contact with an aqueous solution of thiourea or hydrochloric acid solution, or aqueous solution of thiourea and hydrochloric acid solution successively in this order to elute out the PGM in the third step.

The sixth aspect of the present invention is the process of the fifth aspect for separation/recovery of PGM, wherein the hydrochloric acid solution has a chloride ion concentration of 4 mol/L or more.

The seventh aspect of the present invention is the process of the fifth aspect for separation/recovery of PGM, wherein the elution is carried out at 60 to 90°C in the third step.

The eighth aspect of the present invention is the process of the first aspect for separation/recovery of PGM, wherein the third step, when carried out in the presence of an aqueous solution of thiourea, is followed by a step in which the elution effluent is made alkaline and then heated to recover the PGM in the form of sulfide.

The ninth aspect of the present invention is the process of one of the first to eighth aspects for separation/recovery of PGM, wherein the PGM is at least one element selected from the group consisting of platinum, palladium, iridium, rhodium, ruthenium and osmium.

### Detailed Description

The process of the present invention for separation/recovery of PGM is described in detail, in particular with respect to selection of the resin, and the adsorption, washing, elution and PGM recovery steps.

(1) Polyamine-based anion exchange resinThe adsorption step with the aid of polyamine-based anion exchange resin for the present invention is based on the effect of amino groups, each bonded to the adjacent carbon atom, for including the metallic ion (chelating effect). A polyamine-based anion exchange resin having amino groups each serving as the functional group has a higher chelating capacity than an ordinary anion exchange resin. It is known that an aliphatic amine increases in capacity of forming a complex-with a metal by the so-called chelating effect as it has a larger number of amino-bound carbon atoms bonded to each other in series. Moreover, a polyamine-based anion exchange resin, free of quaternary ammonium salt, is a weakly basic resin and tends to adsorb a weakly acidic ion. Therefore, it has been used for separating the sulfate ion in brine water, but not for recovering a noble metal. The polyamine-based anion exchange resin for the present invention is not limited, so long as it has amino groups each serving as the functional group and composed of primary to tertiary amines, and is weakly basic and has a structure expected to bring the chelating effect by the amino groups arranged adjacent to each other.

A PGM (Platinum group metal) forms a chloro complex in a chloride solution. However, there are many weakly complex-acids of PGM that are not completely transformed into a chloro complex, in addition to a stable complex such as a hexachloro complex of platinum. These types of compounds of PGM are difficult to be adsorbed by an ion exchange resin.

The polyamine-based anion exchange resin for the present invention tends to adsorb these weakly complex-acids of PGM that are not completely transformed into a chloro complex, when put in a chloride solution. On the other hand, it sparingly adsorbs many forms of metallic ions, e.g., copper, whose chloro complex-acids is unstable, and those forming a strongly acidic ion, e.g., pentavalent arsenic, hexavalent selenium and hexavalent tellurium, when put in a chloride solution. For these chemical properties, the resin has a characteristic of selectively adsorbing PGM.

(2) First step (adsorption step)

The first step (adsorption step) for the present invention is to selectively adsorb PGM from a chloride solution containing the PGM by the aid of the polyamine-based anion exchange resin. The adsorption may be effected by a known column or batch system.

The chloride solution containing PGM is preferably kept at an oxidation-reduction potential of 700 to 1100mV in the adsorption step, more preferably 800 to 1000mV, still more preferably 850 to 970mV.

A PGM forms an anionic complex most easily when it is a tetravalent ion. Therefore, the chloride solution is preferably kept at an oxidation-reduction potential of 700 to 1100mV, at which major PGM ions are tetravalent. At above 1100mV, on the other hand, the resin may be deteriorated by oxidation.

The chloride solution can be adjusted at a desired oxidation-reduction potential, when incorporated with an oxidant before the adsorption step. When the solution is continuously passed through a column packed with an ion exchange resin for the adsorption step, the effluent from the column may lose the potential by, e.g., a reduced substance adsorbed by the resin. In such a case, the solution is preferably passed after being adjusted again at a potential in the desired range, to improve the yield.

The oxidation-reduction potential is based on an Ag/AgCl electrode.

Treatment temperature in the adsorption is not limited. However, it is preferably in a range from room temperature realizable on a commercial scale to 90°C to prevent deterioration of the resin.

(3) Second step (washing step)

The second step (washing step) is to wash, with the aid of a cleaning fluid, the polyamine-based ion exchange resin adsorption-treated in the first step. The adsorption-treated resin is physically impregnated with the solution to have an impurity component in the pores, although rarely adsorbing a cation, e.g., copper ion, or a strongly acidic ion, e.g., selenium or tellurium ion. It is therefore necessary to wash the ion exchange resin to remove the physically carried solution before the elution treatment, in order for the eluent to recover PGM solution of high quality in the third step.

Water is used as the cleaning fluid. When an impurity element contained in the chloride solution is amenable to hydrolysis, incorporation of hydrochloric acid in the fluid can prevent precipitation caused by the hydrolysis. However, elution of the PGM adsorbed by the ion exchange resin is accelerated as hydrochloric acid concentration increases, as discussed later. Therefore, use of diluted hydrochloric acid is preferable to prevent elution of the PGM during the washing step, and its concentration is preferably below 4mol/L, particularly preferably 1mol/L or less.

Temperature of the cleaning fluid in the second step is not limited. However, it is preferably in a range from room temperature realizable on a commercial scale to 90°C to prevent deterioration of the resin.

(4) Third step (elution step)

The third step for the present invention is to desorb the PGM with the aid of an eluent from the ion exchange resin washing-treated in the second step. The eluents useful for the present invention include an aqueous solution of thiourea as a complex-forming agent that forms stable complexes with many PGM, and hydrochloric acid.

An aqueous solution of thiourea can elute PGM out of the resin over a wide range of concentration, because thiourea has a high capacity for forming a complex with the PGM. Concentration of the aqueous solution is not limited. However, it is preferably 2.5 to 10% by weight in consideration of its solubility in water, decomposition by an acid remaining slightly in the resin and economic efficiency.

Hydrochloric acid, when used, stabilizes the chloro complex in the solution increasingly as its concentration increases, and hence speeds up the elution. Therefore, concentration of hydrochloric acid in the eluent is preferably 4mol/L or more, more preferably 6mol/L. However, its practical upper limit is 12mol/L in consideration of solubility of hydrogen chloride.

The elution may be effected even at room temperature in the third step, but preferably at 60°C or higher, because increasing temperature accelerates the elution both with an aqueous solution of thiourea and hydrochloric acid. At above 90°C, however, the resin tends to be unstable. Therefore, the solution is kept preferably at 60 to 90°C in the elution step.

When the eluent is passed through the column in the third step, the effluent during the initial stage is thick and contains the PGM at a higher concentration. However, the concentration decreases sharply with time thereafter, and the effluent containing the PGM at a concentration of the order of mg/L will flows out for a while. Elution efficiency should improve, when the effluent flowing out during the latter stage is used as the feed for the next elution.

(5) Step for recoveringPGM

The PGM is recovered as the concentrate from the PGM-containing eluent stream discharged from the third step. When an aqueous solution of thiourea is used as the eluent, for example, the thiourea complex of the PGM is decomposed by oxidation with aqua regia or the like to be transformed into the aqueous solution of the PGM, which is then reduced by a hydrazine or the like to recover the metal.

Moreover, PGM in an aqueous solution of thiourea is hydrolyzed, when kept alkaline, and can be recovered in the form of the sulfide precipitate. The precipitation proceeds even under a neutral condition and at room temperature, although gradually. However, it proceeds quantitatively and acceleratingly as pH and temperature increase. Therefore, the solution is preferably kept at a pH of 11 or more and 60 to 90°C, particularly preferably 80 to 90°C. Filtration of the precipitate separates ampholytic metals (e.g., aluminum and zinc), nonferrous metals (e.g., silicon), and metallic ions that form a complex with a sulfide ion (e.g., antimony, tin, arsenic, germanium, molybdenum, selenium and tellurium) into the filtrate, to improve purity of the PGM in the recovered precipitate.

When a hydrochloric acid solution is used as the eluent, on the other hand, the PGM can be easily recovered as the metallic powder from the chloride solution, after being reduced. It can be also recovered as the chloro complex salts by incorporating the hydrochloric acid solution with ammonium chloride or the like.

EXAMPLES

The present invention is described by EXAMPLES and COMPARATIVE EXAMPLES, which by no means limit the present invention. In EXAMPLES, quantity of the effluent discharged from the column packed with a resin after it was charged into the column is represented by the relative value based on the resin bed volume (hereinafter referred to as BV). The metallic ions were quantitatively analyzed by ICP emission analysis.

EXAMPLE 1

(1) Adsorption stepA cylindrical glass column (General, Bio-column BC series, CF-18-1, outer diameter: 18mm, length: 300mm, inner diameter: 14mm) was packed with 40mL of a polyamine-based anion exchange resin (Sumitomo Chemical, PUROLITE A-830). The feed solution was an aqueous solution having a composition given in Table 1 and chloride ion concentration of 86g/L. It was incorporated with sodium chlorite to adjust its oxidation-reduction potential at 970mV (based on an Ag/AgCl electrode), and passed through the column at 200mL/hour at room temperature. Table 2 gives the composition of the effluent solution (adsorption-treated solution) discharged from the adsorption column to each BV level.

TABLE 1
Composition of the feed solution (g/L)

| Pt | Pd | Ir | Ru | Rh | Cu | Se | Te | As |
|---|---|---|---|---|---|---|---|---|
| 0.047 | 0.19 | 0.030 | 0.14 | 0.025 | 7.76 | 20.5 | 3.31 | 1.99 |

TABLE 2
Relationship between effluent quantity (BV) and
composition (g/L) of the adsorption-treated solution

| BV | Pt | Pd | Ir | Ru | Rh | Cu | Se | Te | As |
|---|---|---|---|---|---|---|---|---|---|
| 1 | 0.0002 | <0.0001 | <0.0001 | 0.0009 | <0.0001 | 2.34 | 3.39 | 0.72 | 0.66 |
| 2 | 0.0002 | 0.0002 | 0.0001 | 0.004 | 0.0005 | 5.97 | 15.3 | 2.43 | 1.65 |
| 3 | 0.0002 | 0.0002 | <0.0001 | 0.008 | 0.001 | 7.41 | 19.4 | 3.03 | 1.85 |
| 4 | 0.0002 | 0.0003 | 0.0009 | 0.01 | 0.001 | 7.76 | 20.4 | 3.23 | 1.87 |
| 6 | 0.0003 | 0.0003 | 0.001 | 0.014 | 0.002 | 7.93 | 20.9 | 3.32 | 1.88 |
| 9 | 0.0004 | 0.0003 | 0.002 | 0.019 | 0.003 | 7.87 | 21.1 | 3.33 | 1.88 |
| 11 | 0.0005 | 0.0003 | 0.002 | 0.022 | 0.003 | 7.84 | 21.1 | 3.36 | 1.88 |
| 14 | 0.001 | 0.0006 | 0.003 | 0.024 | 0.004 | 7.81 | 21.1 | 3.35 | 1.87 |
| 17 | 0.002 | 0.001 | 0.003 | 0.026 | 0.004 | 7.55 | 20.4 | 3.24 | 1.81 |
| 19 | 0.002 | 0.002 | 0.003 | 0.027 | 0.004 | 7.38 | 19.9 | 3.17 | 1.8 |
| 21 | 0.003 | 0.004 | 0.005 | 0.039 | 0.005 | 7.87 | 20.4 | 3.37 | 1.88 |
| 24 | 0.006 | 0.010 | 0.007 | 0.041 | 0.006 | 7.91 | 20.8 | 3.34 | 1.88 |
| 27 | 0.009 | 0.018 | 0.009 | 0.044 | 0.007 | 7.9 | 20.8 | 3.36 | 1.91 |
| 29 | 0.013 | 0.028 | 0.009 | 0.046 | 0.007 | 7.13 | 18.7 | 3.03 | 1.9 |
| 32 | 0.015 | 0.039 | 0.011 | 0.05 | 0.008 | 7.72 | 20.4 | 3.28 | 1.88 |
| 34 | 0.018 | 0.054 | 0.011 | 0.053 | 0.008 | 7.51 | 19.9 | 3.18 | 1.84 |

As shown in Table 2, each of copper, selenium, tellurium and arsenic in the treated solution had a concentration essentially the same as that in the feed solution at a BV level of 3 or after, whereas each of the PGM had a concentration reduced as a result of the adsorption treatment at a BV level of 34, by which is meant that adsorption still continued even when the solution was passed through the column to such a high BV level. The low concentrations at BV levels of 1 and 2 resulted from water contained when the column was packed with the resin.

Table 3 gives the average adsorption rate from discharge of the initial effluent to each BV level, estimated from the data given in Table 2.

TABLE 3
Average adsorption rate (%) from discharge
of the initial effluent to each BV level

| BV | Pt | Pd | Ir | Ru | Rh | Cu | Se | Te | As |
|---|---|---|---|---|---|---|---|---|---|
| 1 | 99.6 | 99.9 | 99.7 | 99.4 | 99.6 | 69.8 | 83.5 | 78.2 | 66.8 |
| 2 | 99.6 | 99.9 | 99.7 | 98.3 | 98.8 | 46.8 | 54.8 | 52.8 | 42.3 |
| 3 | 99.6 | 99.9 | 99.7 | 96.9 | 97.9 | 32.6 | 38.2 | 37.9 | 30.4 |
| 4 | 99.6 | 99.9 | 99.0 | 95.9 | 97.4 | 24.5 | 28.9 | 29.1 | 24.4 |
| 6 | 99.5 | 99.9 | 98.1 | 93.6 | 95.3 | 13.9 | 16.6 | 17.4 | 16.9 |
| 9 | 99.4 | 99.9 | 96.7 | 91.5 | 93.2 | 9.6 | 11.1 | 12.3 | 13.7 |
| 11 | 99.3 | 99.9 | 96.0 | 89.9 | 92.0 | 7.2 | 8.0 | 9.2 | 11.9 |
| 14 | 99.0 | 99.8 | 94.9 | 89.6 | 90.6 | 5.8 | 6.0 | 7.3 | 10.8 |
| 17 | 98.5 | 99.8 | 94.1 | 87.5 | 89.6 | 5.3 | 5.1 | 6.5 | 10.5 |
| 19 | 98.2 | 99.7 | 93.6 | 86.7 | 88.9 | 5.2 | 4.9 | 6.2 | 10.4 |
| 21 | 97.7 | 99.5 | 92.5 | 85.0 | 87.9 | 4.5 | 4.4 | 5.3 | 9.9 |
| 24 | 96.5 | 99.0 | 90.8 | 83.5 | 86.6 | 3.8 | 3.7 | 4.7 | 9.4 |
| 27 | 95.0 | 98.1 | 89.0 | 82.0 | 85.1 | 3.2 | 3.2 | 4.0 | 8.9 |
| 29 | 93.0 | 97.0 | 87.4 | 80.7 | 84.0 | 3.7 | 3.7 | 4.4 | 8.5 |
| 32 | 91.0 | 95.6 | 85.4 | 79.4 | 82.7 | 3.4 | 3.4 | 4.1 | 8.2 |
| 34 | 88.7 | 93.7 | 83.7 | 78.0 | 81.6 | 3.4 | 3.4 | 4.1 | 8.2 |

The results given in Table 3 indicate that each of the platinum group is adsorbed at 90% or more to a BV level of 9 or less, although they are adsorbed differently.

In other words, each of the PGM is adsorbed at 90% or more, when the solution is passed through the column packed with 40mL of the resin at 200mL/hour to a volume of 360mL. It is found, based on these data, that the resin volume, and charge rate and quantity can be set for a specific purpose and that the adsorption step for the present invention can realize an industrially advantageous adsorption rate.

(2) Washing stepThe adsorption-treated resin was washed with a flow of 120mL (3 times of the BV) of 1mol/L hydrochloric acid, passed over the resin at 80mL/hour. It was then washed in a flow of 120mL (3 times of the BV) of water, to prevent the hydrochloric acid from coming into contact with thiourea in the subsequent step. The effluent analysis results are given in Tables 4 and 5.

TABLE 4
Relationship between effluent quantity (BV) from the 1 mol/L
hydrochloric acid washing step and effluent composition (g/L)

| BV | Pt | Pd | Ir | Ru | Rh | Cu | Se | Te | As |
|---|---|---|---|---|---|---|---|---|---|
| 1 | 0.002 | 0.004 | 0.005 | 0.014 | 0.002 | 5.0 | 2.3 | 0.55 | 2.9 |
| 2 | <0.0001 | <0.0001 | 0.0003 | 0.007 | 0.0004 | 0.28 | 0.60 | 0.039 | 0.92 |
| 3 | <0.0001 | <0.0001 | 0.0004 | 0.005 | 0.0002 | 0.091 | 0.25 | 0.018 | 0.53 |

TABLE 5
Relationship between effluent quantity (BV) from the
water washing step and effluent composition (g/L)

| BV | Pt | Pd | Ir | Ru | Rh | Cu | Se | Te | As |
|---|---|---|---|---|---|---|---|---|---|
| 1 | <0.0001 | <0.0001 | <0.0001 | 0.006 | <0.0001 | 0.065 | 0.17 | 0.017 | 0.45 |
| 3 | <0.0001 | <0.0001 | <0.0001 | 0.004 | <0.0001 | 0.011 | 0.02 | 0.004 | 0.11 |

As shown in Tables 4 and 5, each PGM was washed out into the washing solution to a limited extent after resin was washed with 80mL (2 times of the BV) of hydrochloric acid, whereas each of copper, selenium, tellurium and arsenic was washed out at a high concentration during the initial stage of the hydrochloric acid washing step, and its concentration in the effluent solution rapidly decreased thereafter by the hydrochloric acid and water washing. In other words, it is found that the resin is physically impregnated with these impurity elements in the pores or the like, or they are deposited in the pores, and that they can be removed from the resin by the washing procedure. Therefore, the PGM are adsorbed by the resin, and the impurity elements, or those other than the PGM, can be collected in the effluent solution from the adsorption step and that from the subsequent washing step.

(3) Elution stepThe washing-treated resin was treated for elution at room temperature with a 2.5% by weight aqueous solution of thiourea, which was passed over the resin at 200mL/hour.

The effluent from the elution step was incorporated with a 24% by weight aqueous solution of sodium hydroxide to be adjusted at a pH of 13, and heated to 80°C. The effluent was filtered to remove the resulting sulfide precipitate, and both precipitate and filtrate were analyzed. Each of the platinum was present in the filtrate at 1mg/L or less, by which is meant that the process of the present invention can be used to recover one or more element in the form of sulfide precipitate from an aqueous solution of thiourea. Table 6 gives compositions of the effluent from the elution step, estimated from the precipitate analysis results, and Table 7 gives cumulative elution rate of each metal at an aqueous thiourea solution quantity (BV) of 14.0 passed over the resin.

TABLE 6
Relationship between aqueous thiourea solution quantity (BV)
for elution and elution effluent composition (g/L)

| BV | Pt | Pd | Ir | Ru | Rh | Cu | Se | Te |
|---|---|---|---|---|---|---|---|---|
| 1.2 | 0.003 | 0.013 | 0.001 | 0.019 | 0.001 | 0.053 | 0.075 | 0.003 |
| 2.6 | 0.611 | 1.778 | 0.006 | 0.972 | 0.008 | 0.006 | 0.667 | 0.011 |
| 4.4 | 0.700 | 1.780 | 0.004 | 0.480 | 0.004 | 0.002 | 0.108 | 0.002 |
| 6.7 | 0.117 | 0.333 | 0.007 | 0.200 | 0.002 | 0.002 | 0.030 | 0.002 |
| 9.1 | 0.005 | 0.021 | 0.003 | 0.076 | 0.001 | 0.002 | 0.005 | 0.002 |
| 11.4 | 0.001 | 0.005 | 0.002 | 0.041 | 0.001 | 0.002 | 0.003 | 0.002 |
| 14.0 | 0.000 | 0.003 | 0.001 | 0.020 | 0.001 | 0.002 | 0.002 | 0.002 |

TABLE 7
Cumulitive elution rate (%) of each element at an aqueous thiourea
solution quantity (BV) of 13.95 passed over the resin

| Pt | Pd | Ir | Ru | Rh | Cu | Se | Te |
|---|---|---|---|---|---|---|---|
| 99.6 | 99.7 | 8.6 | 81.4 | 2.3 | 47.4 | 26.3 | 11.1 |

The results given in Table 6 indicate that elution of each PGM is almost completed at a BV level of 6.7, and that copper, selenium and tellurium are eluted to only a limited extent, because they have been already removed in the washing step.

Moreover, the results given in Table 7 indicate that platinum, palladium and ruthenium are mostly recovered in the effluent from the elution step with the aqueous solution of thiourea.

The water-washed resin was further treated at 60°C as liquid temperature with 6mol/L hydrochloric acid, which was passed over the resin at 20mL/hour. The effluent analysis results are given in Table 8.

TABLE 8
Relationship between hydrochloric acid quantity (BV)
for elution adn elution effluent composition (g/L)

| BV | Pt | Rh | Pd | Ir | Ru |
|---|---|---|---|---|---|
| 1 | <0.001 | 0.0093 | 0.000064 | 0.038 | 0.027 |
| 2 | <0.001 | 0.05 | 0.001 | 0.13 | 0.034 |
| 3 | <0.001 | 0.059 | 0.0013 | 0.093 | 0.025 |
| 4 | <0.001 | 0.045 | <0.0013 | 0.063 | 0.022 |
| 5 | <0.001 | 0.047 | <0.001 | 0.051 | 0.022 |
| 6 | 0.0017 | 0.027 | 0.00025 | 0.027 | 0.016 |
| 7 | 0.0015 | 0.019 | 0.00029 | 0.018 | 0.014 |
| 8 | 0.001 | 0.014 | 0.00045 | 0.013 | 0.012 |
| 9 | 0.00046 | 0.0084 | <0.001 | 0.0084 | 0.01 |
| 10 | 0.0008 | 0.011 | <0.001 | 0.011 | 0.013 |
| 11 | 0.00081 | 0.01 | <0.001 | 0.01 | 0.012 |
| 12 | 0.00053 | 0.01 | <0.001 | 0.0094 | 0.012 |
| 13 | 0.0006 | 0.01 | <0.001 | 0.0083 | 0.011 |
| 14 | 0.00013 | 0.0097 | <0.001 | 0.0084 | 0.012 |
| 15 | 0.0003 | 0.0087 | <0.001 | 0.0074 | 0.011 |

The results given in Table 8 indicate that not only iridium and rhodium but also residual ruthenium can be eluted out.

It is apparent, based on the above results, that the process of the present invention can separate/recover platinum, palladium, ruthenium, iridium and rhodium from a chloride solution which contains copper, selenium, tellurium and arsenic at a higher content than the PGM.

EXAMPLE 2

The recovery treatment was carried out in the same manner as in EXAMPLE 1, except that 60mL of the resin was used for the adsorption step, 180mL of 1mol/L diluted hydrochloric acid was passed over the resin at 80mL/hour in the washing step, 180mL of water was passed over the resin in the water-washing step, and the washed resin was withdrawn from the column and divided into 3 parts, which were put in 100mL of a 2.5% by weight aqueous solution of thiourea with stirring for 1 hour at 40, 60 or 80°C as solution temperature. The results are given in Table 9.

TABLE 9
Relationship between elution temperature and contencts (g/L)
of the PGM in the elution effluent solution

| elution temperature (° C.) | Pt | Pd | Ru | IR | Rh |
|---|---|---|---|---|---|
| 40 | 0.079 | 0.36 | 0.093 | 0.002 | 0.004 |
| 60 | 0.089 | 0.36 | 0.14 | 0.004 | 0.02 |
| 80 | 0.088 | 0.34 | 0.16 | 0.014 | 0.038 |

The results given in Table 9 indicate that content of each of the PGM in the elution effluent solution increases as temperature increases. Particularly noted is the increased content of rhodium at 60°C or higher. In other words, the elution can be carried out efficiently at 60°C or higher as liquid temperature.

EXAMPLE 3

The adsorption step was carried out in the same manner as in EXAMPLE 1, and the effluent solution from the adsorption step was sampled after it was discharged to 600mL, and analyzed for its PGM contents. The results are given in Table 10.

COMPARATIVE EXAMPLE 1

The adsorption treatment was carried out in the same manner as in EXAMPLE 1, except that the anion exchange resin was replaced by a weakly basic, non-polyamine-based anion exchange resin (Sumitomo Chemical, DUOLITE A375LF). The effluent solution from the adsorption step was sampled after it was discharged to 600mL, and analyzed for its PGM contents. The results are given in Table 10.

COMPARATIVE EXAMPLE 2

The adsorption treatment was carried out in the same manner as in EXAMPLE 1, except that the anion exchange resin was replaced by a weakly basic, non-polyamine-based anion exchange resin (Mitsubishi Chemical, DIAION® WA21J). The effluent solution from the adsorption step was sampled after it was discharged to 600mL, and analyzed for its PGM contents. The results are given in Table 10.

TABLE 10
Relationship between resin type and contents (g/L)
of the PGM in the adsorption treated solution

| | resin | Pt | Pd | Ir | Ru | Rh |
|---|---|---|---|---|---|---|
| EXAMPLE 3 | PUROLITE A-835 | 0.0005 | 0.0004 | 0.002 | 0.016 | 0.002 |
| COMPARATIVE | DUOLITE A375LF | 0.001 | 0.012 | 0.009 | 0.030 | 0.012 |
| EXAMPLE 1 | | | | | | |
| COMPARATIVE | DIAION WA21J | 0.005 | 0.007 | 0.007 | 0.024 | 0.007 |
| EXAMPLE 2 | | | | | | |

As shown in Table 10, each effluent from the adsorption step with the weakly basic, non-polyamine-based anion exchange resin contained each PGM at a higher content than the one from the step with the polyamine-based anion exchange resin for the present invention.

In other words, the polyamine-based anion exchange resin for the present invention is superior to the weakly basic, non-polyamine-based anion exchange resin in capacity of adsorbing each PGM.

The present invention can, using an ion exchange resin, selectively adsorb and elute PGM in the form of chloride, e.g., chloro complex, irrespective of its form, from a chloride solution containing PGM at a relatively low concentration and an impurity element at a high concentration, and hence is of very high industrial value.

What is Claimed is:

1. A process for separation/recovery of platinum group metals (PGM) from a chloride solution containing the PGM and an impurity element, comprising a first step of selectively adsorbing the PGM by bringing a polyamine-based anion exchange resin into contact with the solution to form adsorption-treated resin, a second step of washing the adsorption-treated resin to form washing-treated resin, and third step of eluting the PGM from the washing-treated resin to form an effluent.

2. The process according to Claim 1 for separation/recovery of PGM, further comprising the step of keeping the chloride solution at an oxidation-reduction potential of 700 to 1100mV (based on an Ag/AgCl electrode).

3. The process according to Claim 1 for separation/recovery of PGM, wherein said washing step comprises the steps of washing the adsorption-treated resin with a diluted hydrochloric acid solution or water, or with diluted hydrochloric acid solution and then water.

4. The process according to Claim 3 for separation/recovery of PGM, wherein the diluted hydrochloric acid solution has a chloride ion concentration of below 4mol/L in said second step.

5. The process according to Claim 1 for separation/recovery of PGM, wherein said elution step comprises the step of bringing the washing-treated resin into contact with an aqueous solution of thiourea or hydrochloric acid solution, orwith aqueous solution of thiourea and then hydrochloric acid solution successively.

6. The process according to Claim 5 for separation/recovery of PGM, wherein the hydrochloric acid solution has a chloride ion concentration of 4mol/L or more.

7. The process according to Claim 5 for separation/recovery of PGM, wherein said elutingstep is carried out at 60 to 90°C .

8. The process according to Claim 1 for separation/recovery of PGM, wherein said eluting step, when carried out in the presence of an aqueous solution of thiourea, is followed by a step in which the elution effluent is made alkaline and then heated to recover the PGM in the form of sulfide.

9. The process according to Claim 1 for separation/recovery of PGM, wherein the PGM is at least one element selected from the group consisting of platinum, palladium, iridium, rhodium, ruthenium and osmium.

10. The process according to Claim 2, wherein the PGM is at least one element selected from the group consisting of platinum, palladium, iridium, rhodium, ruthenium and osmium.

11. The process according to Claim 3, wherein the PGM is at least one element selected from the group consisting of platinum, palladium, iridium, rhodium, ruthenium and osmium.

12. The process according to Claim 4, wherein the PGM is at least one element selected from the group consisting of platinum, palladium, iridium, rhodium, ruthenium and osmium.

13. The process according to Claim 5, wherein the PGM is at least one element selected from the group consisting of platinum, palladium, iridium, rhodium, ruthenium and osmium.

14. The process according to Claim 6, wherein the PGM is at least one element selected from the group consisting of platinum, palladium, iridium, rhodium, ruthenium and osmium.

15. The process according to Claim 7, wherein the PGM is at least one element selected from the group consisting of platinum, palladium, iridium, rhodium, ruthenium and osmium.

16. The process according to Claim 8, wherein the PGM is at least one element selected from the group consisting of platinum, palladium, iridium, rhodium, ruthenium and osmium.
